(19) United States
(12) Patent Application Publication
(10) Pub. No.: US 2025/0156595 A1
(43) Pub. Date: May 15, 2025

(54) Pointing mechanism, design method, device and storage medium thereof

(71) Applicant: Beijing Goaldrill Technology Co., Ltd., Beijing (CN)

(72) Inventors: Jiaqi CHEN, Beijing (CN); Yanfeng SHI, Beijing (CN); Xiaoming CAO, Beijing (CN)

(21) Appl. No.: 18/635,823

(22) Filed: Apr. 15, 2024

(30) Foreign Application Priority Data
Nov. 9, 2023 (CN) 2023114858750

(51) Int. Cl. G06F 30/17; E21B 7/04

(52) U.S. Cl. CPC G06F 30/17; E21B 7/046

(57) ABSTRACT

The present invention is suitable for use in the technical field of drilling equipment, and provides a design method of pointing mechanism, wherein the method comprises the following steps: building a model for the pointing mechanism, wherein the model of the pointing mechanism at least comprises a first stretching lever, a second stretching lever, a main support arm and a directional frame; building a global coordinate system, defining geometric information, topological information and mechanical information of the models of the components in the global coordinate system; building a dynamics model for the pointing mechanism based on the geometric information, the topological information and the mechanical information of the models of the components; acquiring working conditions and performance requirements on the pointing mechanism, and simulating and optimizing the dynamics model based on the working conditions and the performance requirements.

### TECHNICAL FIELD

The present invention belongs to the technical field of drilling equipment, especially a pointing mechanism, design method, device and storage medium thereof.

### BACKGROUND TECHNOLOGY

For drilling machines and drilling equipment, in order to accommodate to more working conditions and widen the scope of drilling construction, before the drilling work starts, it is necessary to adjust the height of the drilling machine and an included angle between the drilling machine and the horizontal plane to satisfy design requirements on the aperture position and the inclination angle. Conventional rotary horizontal drilling machines usually adjust the heights and the angles with structures of two opposite pivots and oil tanks. For coiled tubing drilling machines, at the intermediate portions, coiled tubing is used, the injector heads that the coiled tubing pushes forward have no displacement relative to the drilling machines, therefore, the displacement adjustment structures employed for conventional horizontal drilling machines are not suitable for use in coiled tubing drilling machines, the adjusting abilities of the displacement adjustment devices for coiled tubing drilling machines are quite limited, and for complex working conditions, the displacement adjustment devices are not sufficient, and without increasing the cost substantially, it is difficult to improve the structural strength of the devices efficiently.

### SUMMARY OF THE INVENTION

Embodiments of the present invention aim to provide a design method of pointing mechanism, in order to solve the problems that, the conventional displacement adjustment structures for horizontal drilling machines are not suitable for use in coiled tubing drilling machines, the adjusting abilities of the displacement adjustment devices of coiled tubing drilling machines are quite limited, for complex working condition, the displacement adjustment devices are not sufficient, and without increasing the cost substantially, it is difficult to improve the structural strength of the devices efficiently.

Embodiments of the present invention are realized in this way, a design method of pointing mechanism, wherein the method comprises the following steps: building a model for the pointing mechanism, wherein the model of the pointing mechanism at least comprises a first stretching lever, a second stretching lever, a main support arm and a directional frame; wherein one end of the first stretching lever is connected with the main support arm, another end of the first stretching lever is connected with a base frame of the pointing mechanism; an end of the main support arm is connected with the base frame of the pointing mechanism, another end of the main support arm is connected with the directional frame; one end of the second stretching lever is connected with the main support arm, and another end of the second stretching lever is connected with the directional frame; acquiring initial component parameters representing dimensions of models of components, and parameters of initial connection relationships representing connection relationships and/or connection positions of the models of the components; building a global coordinate system, defining geometric information, topological information and mechanical information of the models of the components in the global coordinate system; building a dynamics model for the pointing mechanism based on the geometric information, the topological information and the mechanical information of the models of the components; acquiring working conditions and performance requirements on the pointing mechanism, and simulating and optimizing the dynamics model based on the working conditions and the performance requirements.

Another purpose of the present invention is to provide a design device of the pointing mechanism, wherein the design device of the pointing mechanism comprises: a pointing mechanism model construction module, configured to build a model for the pointing mechanism, wherein the model of the pointing mechanism at least comprises a first stretching lever, a second stretching lever, a main support arm and a directional frame; one end of the first stretching lever is connected with the main support arm, another end of the first stretching lever is connected with a base frame of the pointing mechanism; one end of the main support arm is connected with the base frame of the pointing mechanism, another end of the main support arm is connected with the directional frame; one end of the second stretching lever is connected with the main support arm, another end of the second stretching boom is connected with the directional frame; an initial component parameter and initial connection relationship parameter acquisition module, configured to represent initial component parameters of dimensions of models of components and parameters of initial connection relationships of connection relationships and/or connection positions among the models of the components; a dynamics model construction module, configured to build a global coordinate system, and define geometric information, topological information and mechanical information of the models of the components based on the initial component parameters and the parameters of the initial connection relationships; and building a dynamics model for the pointing mechanism based on the geometric information, the topological information and the mechanical information; and a simulation and optimization module, configured to acquire working conditions and performance requirements of the pointing mechanism and simulate and optimize the dynamics model based on the working conditions and the performance requirements.

Another purpose of embodiments of the present invention is to provide a computer readable medium, wherein a computer program is stored in the computer readable storage medium, and the computer program when being executed by a processor, will have the processor to execute the steps in the design method of the pointing mechanism as set forth in the foregoing paragraphs. Another purpose of embodiments of the present invention is to provide a pointing mechanism, wherein the pointing mechanism is obtained as per the design method of pointing mechanism. With the design method of pointing mechanism provided in the embodiments of the present invention, the drilling machines can be connected with the injector head in a manner with one pivot and two degrees of freedom in a longitudinal direction, so that the injector head of the drilling machine has a higher ability to change when the inclination angle is big, can accommodate to more working conditions, and the structure of the pointing mechanism can be optimized and designed as per actual working conditions and requirements, and higher maximum loads can be achieved with hardware currently available.

### BRIEF DESCRIPTION OF DRAWINGS

FIG. 1 is a flow process diagram showing a design method of pointing mechanism as provided in an embodiment of the present invention;

FIG. 2 is a diagram showing a model of the pointing mechanism as provided in an embodiment of the present invention;

FIG. 3 is a diagram showing a simplified model of the pointing mechanism as provided in an embodiment of the present invention;

FIG. 4 is a diagram showing generalized coordinates of a hinged point O of a main support arm and a longitudinal relationship between a first stretching lever and a second stretching lever as provided in an embodiment of the present invention;

FIG. 5 is a diagram showing working space of boundary points A, B, C and D as provided in an embodiment of the present invention;

FIG. 6 is a diagram showing a global coordinate system of a model of a pointing mechanism as provided in an embodiment of the present invention;

FIG. 7 is another simplified diagram of the pointing mechanism according to an embodiment of the present invention;

FIG. 8 is a diagram showing external forces on the pointing mechanism exerted by any part on a directional frame provided in an embodiment of the present invention;

FIG. 9 is a diagram showing the gravity that the pointing mechanism bears for the main support arm according to an embodiment of the present invention;

FIG. 10 is a diagram showing simulation results according to an embodiment of the present invention;

FIG. 11 is a comparison diagram showing analysis results and INSIDES simulation results of the original parameter model of the injector head with no propulsion according to an embodiment of the present invention;

FIG. 12 is a diagram showing relationships between the propulsion of the lower hydraulic rod and parameters of two included angles in the model with the initial parameters according to an embodiment of the present invention;

FIG. 13 is a diagram showing change curves of the parameters during optimization of the model according to an embodiment of the present invention;

FIG. 14 is a diagram showing the relationships between the propulsion of the lower hydraulic rod and the parameters of two included angles after optimization according to an embodiment of the present invention;

FIG. 15 is a diagram showing a pointing mechanism according to an embodiment of the present invention; and

FIG. 16 is a diagram showing another pointing mechanism according to an embodiment of the present invention;

In the drawings, 10 second stretching lever; 20 main support arm; 30 first stretching lever; 40 directional frame and 50 base frame.

### EMBODIMENTS

To make the purposes, technical solutions and advantages of the present invention more apparent and clearer, hereinafter a detailed description will be further given to the present invention in conjunction with the drawings and the embodiments. It shall be comprehensible that, the embodiments given here are only for explaining the present invention rather than to limit the present invention.

It shall be understandable that, terms “first”, “second” etc. used in the present description can be used to describe all kinds of components, however, unless indicated otherwise, the components are not limited by these terms. The terms are only used to differentiate the first component from the second component. For example, without departing from the scope of the present invention, the first script can be called the second script and similarly, the second script can be called the first script.

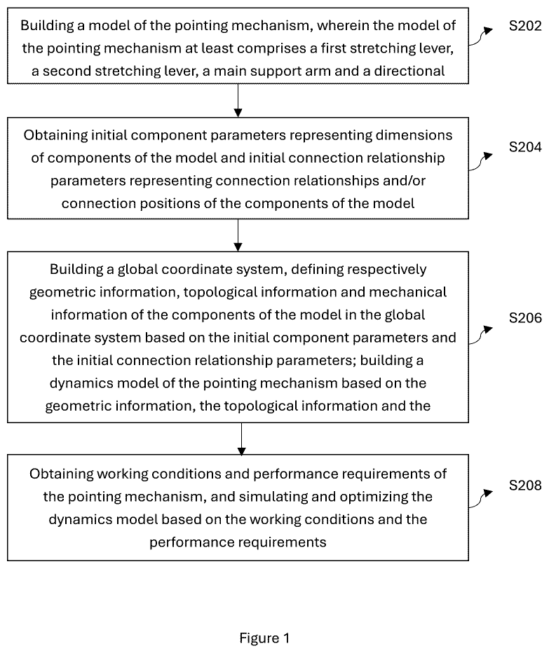

In an embodiment, as shown in FIG. 1, the present invention provides a design method of pointing mechanism, wherein the design method of the pointing mechanism comprises the following steps:
S202: building a model for the pointing mechanism, wherein the model of the pointing mechanism at least comprises a first stretching lever, a second stretching lever, a main support arm and a directional frame; one end of the first stretching lever is connected with the main support arm, another end of the first stretching lever is connected with a base frame of the pointing mechanism; one end of the main support arm is connected with the base frame of the pointing mechanism, another end of the main support arm is connected with the directional frame; one end of the second stretching lever is connected with the main support arm and another end of the second stretching lever is connected with the directional frame;
S204: obtaining initial component parameters representing dimensions of models of components and parameters of initial connection relationships representing connection relationships and/or connection positions of the models of the components;
S205: building a global coordinate system, and defining geometric information, topological information and mechanical information of the models of the components in the global coordinate system based on the initial component parameters and the parameters of the initial connection relationships; building a dynamics model of the pointing mechanism based on the geometric information, the topological information and the mechanical information of the components; and
S208: obtaining working conditions and performance requirements of the pointing mechanism, and simulating and optimizing the dynamics model based on the working conditions and the performance requirements.

For the design method of pointing mechanism according to the present invention, first of all, a model of the injector head is built, with this model, the drilling machine can be connected with the injector head with a single pivot and two degrees of freedom in a longitudinal direction, so that, the injector head of the drilling machine is changeable in a large range of inclination angles, and can be used in more working conditions. With the present technical solution, the model is constructed and simulated, during simulation, well-targeted adjustment can be done to the pointing mechanism as per actual working conditions and requirements, for example, the maximum required loads, further, the design structural parameters of the pointing mechanism can be adjusted with optimization methods, consequently, without changing the hardware currently available, a higher maximum load is obtained.

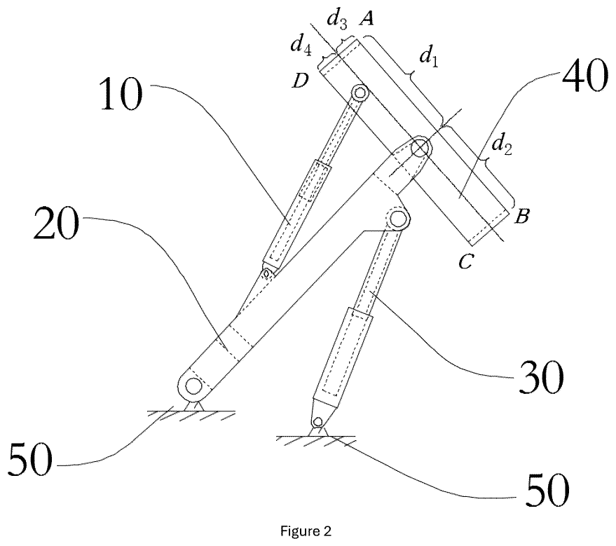

In an embodiment of the present invention, the pointing mechanism for a coiled tubing drilling machine obtained by constructing the model as per the present invention, is shown in FIG. 2, wherein the drilling machine and the injector head are connected in a way with only a single pivot and two degrees of freedom in the longitudinal direction, in this way, the purpose of adjusting the drilling direction is achieved and the pointing mechanism has the degree of freedom in the longitudinal direction in order to satisfy requirements for working in tunnels. The pointing mechanism makes it possible for the included angle between the injector head and the horizontal plane to be changeable in a range of −10° to 90°.

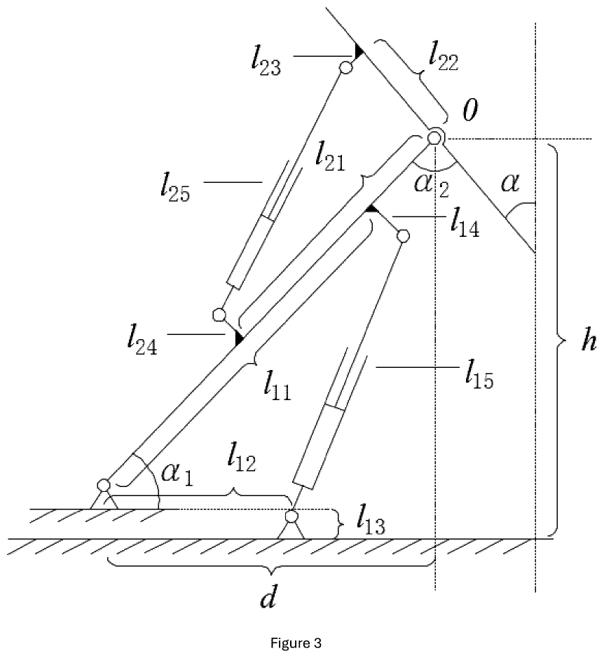

As shown in FIG. 3, a simplified diagram of the model of the pointing mechanism is provided, both sides of the pointing mechanism are symmetric in the middle, as shown in FIG. 3, the pointing mechanism comprises two sets of link lever mechanisms, respectively driven by two hydraulic rods, so that the directional frame has two degrees of freedom to be moveable in the longitudinal direction along two different rotation shafts.

A point O in the directional frame can be a connection point between the directional frame and the support arms, a horizontal distance from the point O to the hinged point between the fixed platform and the main support arm is marked as d, a vertical direction to the fixed platform is marked as h, an included angle between the plane of the directional frame and the vertical guide is marked as an attitude angle α and a direction counterclockwise is defined as positive. In summary, take the directional frame as a planar rigid body, the generalized coordinates of the directional frame can be shown as [d h α].

In FIG. 3, mark the included angle between the main support arm and the horizontal angle to be α₁, the included angle between the main support arm and the directional frame to be α₂, α₁ is dictated by the length l₁₅ of the hydraulic rod 1, α₂ is dictated by the length l₂₅ of the hydraulic rod 2, α₁ and α₂ are independent from each other, and control jointly the included angle α between the plane of the directional frame and the vertical guide, and an equation shows the relationship between α₁, α₂ and α as following:

$$\{ \begin{matrix}d = L \times cos {α}_{1} \\ h = L \times sin {α}_{1} + {l}_{13}\end{matrix} ,$$

The relationships between the included angles α₁ and α₂ and the lengths of the hydraulic rods l₁₅ and l₂₅ are respectively:

$$\{ \begin{matrix}{α}_{1} = {tan}^{− 1} \frac{{l}_{14}}{{l}_{11}} − {tan}^{− 1} \frac{{l}_{13}}{{l}_{12}} + {cos}^{− 1} \frac{{l}_{11}^{2} + {l}_{12}^{2} + {l}_{13}^{2} + {l}_{14}^{2} − {l}_{15}^{2}}{2 \sqrt{( {l}_{11}^{2} + {l}_{14}^{2} ) ( {l}_{12}^{2} + {l}_{13}^{2} )}} \\ {α}_{2} = π − ( {tan}^{− 1} \frac{{l}_{24}}{{l}_{21}} + {tan}^{− 1} \frac{{l}_{23}}{{l}_{22}} + {cos}^{− 1} \frac{{l}_{21}^{2} + {l}_{22}^{2} + {l}_{23}^{2} + {l}_{24}^{2} − {l}_{25}^{2}}{2 \sqrt{( {l}_{21}^{2} + {l}_{24}^{2} ) ( {l}_{22}^{2} + {l}_{23}^{2} )}} )\end{matrix} ,$$

Dimensions and parameters of the initial design of the pointing mechanism are as shown in the following table:

| | | | Value |
|---|---|---|---|
| S.N. | Parameter description | Mark | (mm) |
| 1 | Main support arm length | L | 2000 |
| 2 | Length of main support arm of the link lever mechanism 1 | l₁₁ | 1600 |
| 3 | Horizontal spacing of the base frame of the link lever mechanism 1 | l₁₂ | 800 |
| 4 | Vertical spacing of the base frame of the link lever mechanism 1 | l₁₃ | 150 |
| 5 | Vertical distance from hinge of the link lever mechanism 1 | l₁₄ | 200 |
| | to the main support arm | | |
| 6 | Length of the hydraulic rod of the link lever mechanism 1 | l₁₅ | 840-1340 |
| 7 | Length of the main support arm of the link lever mechanism 1 | l₂₁ | 1200 |
| 8 | Length of the directional frame of the link lever mechanism 1 | l₂₂ | 494 |
| 9 | Vertical distance from the hinge of the link lever mechanism 2 | l₂₃ | 50 |
| | to the directional frame | | |
| 10 | Vertical distance from the hinge of the link lever mechanism 2 | l₂₄ | 150 |
| | to the main support arm | | |
| 11 | Length of the hydraulic rod of the link lever mechanism 2 | l₂₅ | 830-1430 |
| 12 | Length of upper portion of the directional frame | d₁ | 754 |
| 13 | Length of lower portion of the directional frame | d₂ | 661 |
| 14 | Width of front portion of the directional frame | d₃ | 150 |
| 15 | Width of rear portion of the directional frame | d₄ | 150 |

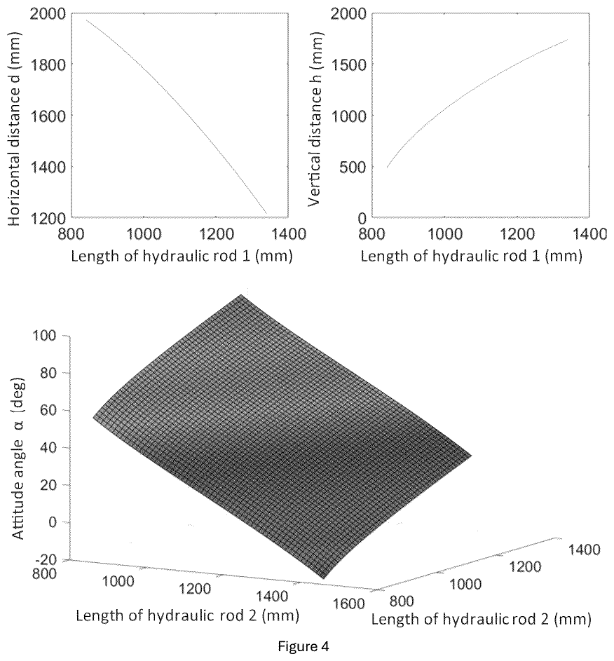

In an embodiment, as per the design parameters, calculating the relationship between the generalized coordinates of the hinged point O between the directional frame and the main support arm and the hydraulic rods 1 and 2, as shown in FIG. 4, wherein the horizontal distance and the vertical distance are dictated by the length of the hydraulic rod 1, and the attitude angle is jointly dictated by the two hydraulic rods, as shown in the drawings, the horizontal distance d changes in a range of 1217 mm to 1972 mm, the vertical distance h changes in a range of 482.6 mm to 1737 mm, and the attitude angle α changes in a range of −19.57° to 97.78°.

Taking the hinged point between the fixed platform and the main support arm as an origin of the coordinates, the horizontal direction as an x axis and the vertical direction as a y axis, and building a coordinate system, wherein the relationship between coordinates of boundary points A, B, C and D and the generalized coordinates of the directional frame [d, h, α] can be expressed as:

$${\vert \text{} \begin{matrix}{x}_{A} & {y}_{A} \\ {x}_{B} & {y}_{B} \\ {x}_{C} & {y}_{C} \\ {x}_{D} & {y}_{D}\end{matrix} ]}^{T} = {[ \begin{matrix}d & h \\ d & h \\ d & h \\ d & h\end{matrix} ]}^{T} + {[ \begin{matrix}− sin α & cos α \\ cos α & sin α\end{matrix} ] [ \begin{matrix}{d}_{1} & {d}_{3} \\ − {d}_{2} & {d}_{3} \\ − {d}_{2} & − {d}_{4} \\ {d}_{1} & − {d}_{4}\end{matrix} ]}^{T} ;$$

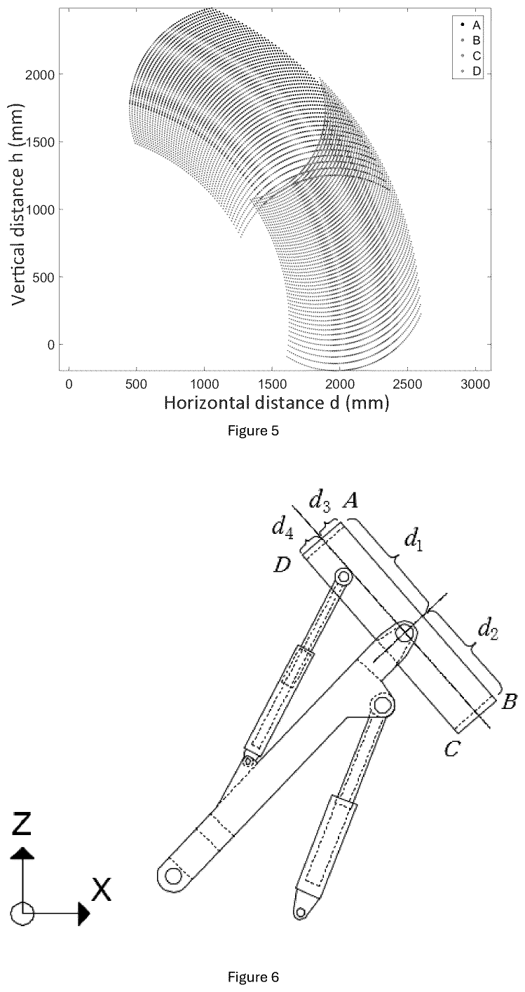

The working space of the boundary points A, B, C and D is shown in FIG. 5, as shown in FIG. 5, the horizontal distance ranges from 448 mm to 2599 mm, and the vertical distance ranges from −195.2 mm to 2489 mm.

In an embodiment, by dynamics design the pointing mechanisms can be made to satisfy the performance requirements of drilling machines. In order to improve the dynamics model construction efficiency of the pointing mechanism and provide tool support for optimized dynamics design, specialized automatic model construction tools will be developed for the pointing mechanism.

In an embodiment, as shown in FIG. 6, for producing the design solution of the pointing mechanism, it is necessary to determine information such as spatial positions, mass inertia parameters, constraints, drive and contact relationships of the components. As shown in the drawings, for the pointing mechanism in the present embodiment, the model has peculiar features, no matter how the design solution changes, these features remain unchanged. It is possible to write the design solution of the pointing mechanism to be dynamics design comprising geometric information, topological information and mechanical information, which is used to define the pointing mechanism and construct parameterized models.

In an embodiment, for the geometric information, first of all, it is necessary to define the geometric information of the components that form the pointing mechanism. Define the global coordinate system to be as shown in FIG. 6, and definitions of the geometric information of the components of the pointing mechanism are as shown in the following table.

| | | | | Data |
|---|---|---|---|---|
| S.N. | Component | Parameter | Description | format |
| 1 | Installation | Pos_MSA1 | Spatial coordinates of an installation opening of the | double[3] |
| | platform | | main support arm 1 in the installation platform | |
| | | Pos_MSA2 | Spatial coordinates of an installation opening of the | double[3] |
| | | | main support arm 2 in the installation platform | |
| | | Pos_HRD_SS1 | Spatial coordinates of an installation opening of the | double[3] |
| | | | lower hydraulic rod 1 in the installation platform | |
| | | Pos_HRD_SS2 | Spatial coordinates of an installation opening of the | double[3] |
| | | | lower hydraulic rodhydraulic rod 2 in the installation | |
| | | | platform | |
| 2 | Main support | Length | Main support arm length (in the x direction) | double |
| | arm 1 | Pos_HRD_MSA | x-z planar coordinates of the installation opening of | double[2] |
| | | | the lower hydraulic rod in the main support arm | |
| | | Pos_HRU_MSA | x-z planar coordinates of the installation opening of | double[2] |
| | | | the upper hydraulic rod in the main support arm | |
| | | Angle | Attitude angle of the main support arm | double |
| 3 | Main support | Length | Main support arm length | double |
| | arm 2 | PosHRD | x-z planar coordinate of the installation opening of the | double[2] |
| | | | lower hydraulic rod in the directional frame | |
| | | PosHRU | x-z planar coordinate of the installation opening of the | double[2] |
| | | | upper hydraulic rod in the directional frame | |
| | | Angle | Main support arm installation attitude angle | double |
| 4 | Directional | Height | Height of the directional frame (in the z direction) | double |
| | frame | Width | Height of the directional frame (in the y direction) | double |
| | | Pos_MSA_DF | x-z planar coordinate of the installation opening of the | double[2] |
| | | | main support arm in the directional frame | |
| | | Pos_HRU_DF | x-z planar coordinate of the installation opening of the | double[2] |
| | | | upper hydraulic rod in the directional frame | |
| | | Angle | Directional frame installation attitude angle | double |
| 5 | Lower | Length | Length of the lower hydraulic rod 1 | double |
| | hydraulic rod 1 | | | |
| 6 | Lower | Length | Length of the lower hydraulic rod 2 | double |
| | hydraulic rod 2 | | | |
| 7 | Upper | Length | Length of the upper hydraulic rod 1 | double |
| | hydraulic rod 1 | | | |
| 8 | Upper | Length | Length of the upper hydraulic rod 2 | double |
| | hydraulic rod 2 | | | |

In an embodiment, for the topological information, the way to build the model is as shown in the following table, wherein the elements in the lower left corner and the elements in the upper right corner are symmetric relative to the diagonal line. Especially, the installation platform and the ground are connected and bonded.

| | | Main | Main | Lower | Lower | Upper | Upper | |
|---|---|---|---|---|---|---|---|---|
| | Installation | support | support | hydraulic | hydraulic | hydraulic | hydraulic | Directional |
| | platform | arm 1 | arm 2 | rod 1 | rod 2 | rod 1 | rod 2 | frame |
| Installation | \ | Revolute | \ | Linear | Linear | \ | \ | \ |
| platform | | pair | | constraint | constraint | | | |
| Main | | \ | Fixed | Revolute | \ | Revolute | \ | Linear |
| support | | | constraint | pair | | pair | | constraint |
| arm 1 | | | | | | | | |
| Main | | | \ | \ | | \ | Revolute | \ |
| support | | | | | | | pair | |
| arm 2 | | | | | | | | |
| Lower | | | | \ | \ | \ | \ | \ |
| hydraulic | | | | | | | | |
| rod 1 | | | | | | | | |
| Lower | | | | | \ | \ | \ | \ |
| hydraulic | | | | | | | | |
| rod 2 | | | | | | | | |
| Upper | | | | | | \ | \ | Revolute |
| hydraulic | | | | | | | | pair |
| rod 1 | | | | | | | | |
| Upper | | | | | | | \ | Linear |
| hydraulic | | | | | | | | constraint |
| rod 2 | | | | | | | | |
| Directional | | | | | | | | \ |
| frame | | | | | | | | |

In an embodiment, after defining the geometric information and the topological information of the components it is necessary to further define the mechanical information, as shown in the following table:

Rigid body mechanical parameters

| S.N. | Description | Meaning | Data format |
|---|---|---|---|
| 1 | MASS | Mass | double |
| 2 | IP | Inertia tensor | double[6] |
| 3 | QG | Position of center of gravity | double[3] |
| 4 | PHIG | Fixed coordinate system position | double[3] |
| | | (rotation vector) | |

In an embodiment, among the dynamics design parameters, parameters such as the attitudes of the main support arms, the directional frame, the upper hydraulic rods and the lower hydraulic rods, the position of the directional frame, and the positions of the upper hydraulic rods can be determined from the height of the directional frame and the angle of the directional frame, relations among them are called member functions, specifically the member functions of the members are as following:

The main support arm attitude calculation function:

| | Description | Symbol | Data format |
|---|---|---|---|
| Input parameter | Directional frame height | h | 1*1 |
| Output parameter | Main support arm attitude | α_{MSA} | 1*1 |

The calculation equation is as follows:

$${α}_{MSA} = arcsin \frac{h}{{L}_{MSA} ,}$$

Wherein L_{MSA} is a length of the main support arms.

The directional frame position calculation function:

| | | | Data |
|---|---|---|---|
| | Description | Symbol | format |
| Input parameter | Height of the directional frame | h | 1*1 |
| | Angle of the directional frame | α | 1*1 |
| Output parameter | Position of the directional frame | r_{DF} | 3*1 |
| | Attitude of the directional frame | α_{DF} | 1*1 |

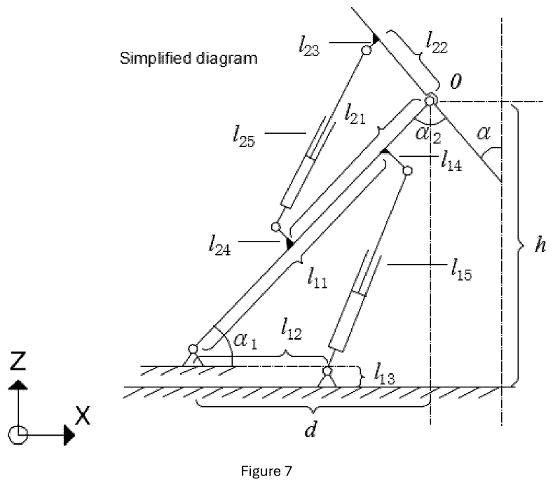

As shown in FIG. 7, the calculation equation is as follows:

$$\{ \begin{matrix}\begin{matrix}{r}_{DF} = {P}_{MSA} + [ \begin{matrix}cos {α}_{MSA} & 0 & − sin {α}_{MSA} \\ 0 & 1 & 0 \\ sin {α}_{MSA} & 0 & cos {α}_{MSA}\end{matrix} ] [ \begin{matrix}{L}_{MSA} \\ 0 \\ 0\end{matrix} ] \\ {α}_{DF} = α\end{matrix}\end{matrix} ,$$

The lower hydraulic rod length and attitude calculation function:

| | | | Data |
|---|---|---|---|
| | Description | Symbol | format |
| Input parameter | Height of the directional frame | h | 1*1 |
| Output | Length of the lower hydraulic rod | L_{HRD} | 1*1 |
| parameter | Attitude of the lower hydraulic rod | α_{HRD} | 1*1 |
| | (included angle with the axis x) | | |

By solving the function, the length of the lower hydraulic rod L_{HRD} can be obtained:

$$arc sin \frac{h - {l}_{13}}{{L}_{MSA}} = {tan}^{- 1} \frac{{l}_{14}}{{l}_{11}} - {tan}^{- 1} \frac{{l}_{13}}{{l}_{12}} + {cos}^{- 1} \frac{{l}_{11}^{2} + {l}_{12}^{2} + {l}_{13}^{2} + {l}_{14}^{2} - {L}_{HRD}^{2}}{2 \sqrt{( {l}_{11}^{2} + {l}_{14}^{2} ) ( {l}_{12}^{2} + {l}_{13}^{2} )}} ,$$

By solving the function, the attitude of the lower hydraulic rod L_{HRD} can be obtained:

$${α}_{HRD} = π - {tan}^{- 1} \frac{{l}_{13}}{{l}_{12}} - {cos}^{- 1} \frac{- {l}_{11}^{2} + {l}_{12}^{2} + {l}_{13}^{2} - {l}_{14}^{2} + {L}_{HRD}^{2}}{2 {L}_{HRD} \sqrt{( {l}_{12}^{2} + {l}_{13}^{2} )}} ,$$

In an embodiment, the length and attitude calculation function for the upper hydraulic rod is as following:

| | | | Data |
|---|---|---|---|
| | Description | Symbol | format |
| Input parameter | Height of the directional frame | h | 1*1 |
| | Angle of the directional frame | α | 1*1 |
| Output | Length of the upper hydraulic rod | L_{HRU} | 1*1 |
| parameter | Position of the upper hydraulic rod | r_{HRU} | 3*1 |
| | Attitude of the upper hydraulic rod | α_{HRU} | 1*1 |
| | (included angle with the axis x) | | |

By solving the following equation the length of the lower hydraulic rod L_{HRU} can be obtained:

$$\frac{π}{2} + arc sin \frac{h - {l}_{13}}{{L}_{MSA}} - α = {tan}^{- 1} \frac{{l}_{24}}{{l}_{21}} + {tan}^{- 1} \frac{{l}_{23}}{{l}_{22}} + {cos}^{- 1} \frac{{l}_{21}^{2} + {l}_{22}^{2} + {l}_{23}^{2} + {l}_{24}^{2} - {L}_{HRU}^{2}}{2 \sqrt{( {l}_{21}^{2} + {l}_{24}^{2} ) ( {l}_{22}^{2} + {l}_{23}^{2} )}} ,$$

By solving the following equation the attitude of the upper hydraulic rod L_{HRU} can be obtained:

$${α}_{HRU} = arc sin \frac{h - {l}_{13}}{{L}_{MSA}} + arc sin \frac{{l}_{22} - {l}_{24}}{{L}_{HRU}} ,$$

By solving the following equation the position of the upper hydraulic rod L_{HRU} can be solved:

$${r}_{HRU} = {P}_{MSA} + [ \begin{matrix}cos {α}_{MSA} & 0 & - sin {α}_{MSA} \\ 0 & 1 & 0 \\ sin {α}_{MSA} & 0 & cos {α}_{MSA}\end{matrix} ] [ \begin{matrix}{L}_{MSA} - {l}_{21} \\ 0 \\ {l}_{24}\end{matrix} ] .$$

In an embodiment, design optimization of the parameters is further conducted based on the model of the pointing mechanism built according to dynamics design rules, as the movement relationships of the pointing mechanism are quite simple, to improve design optimization efficiency, the virtual principle is used to induce the bearing conditions of the upper and lower hydraulic rods.

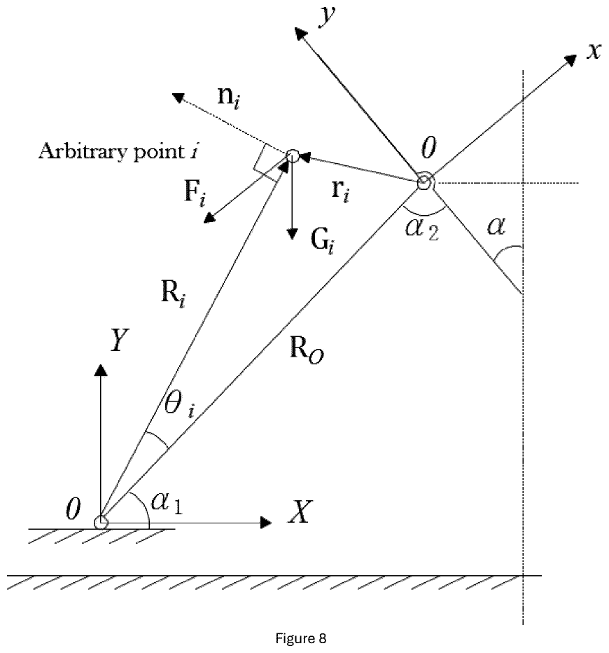

As shown in FIG. 8, according to the virtual work principle:

$${\sum }_{i = 1}^{n} {F}_{i} \cdot δ {q}_{i} = 0$$

Taking virtual displacement to be the rotation angle of the main support arms δα₁, writing the uilibrium equation of the system:

$$( F + G ) \cdot δ {α}_{1} \cdot {L}_{MSA} n + {F}_{HRD} \cdot δ {L}_{HRD} ( {α}_{1} ) = 0 , \qquad ( 1 )$$

Wherein, F stands for reaction force against the injection force, G stands for the gravity of the injector head, assuming that the working points of them are on a straight line where the center shaft of the hinge at the top portion of the main support arm is located, n is a unit vector along a direction of the virtual displacement of the hinge at the top portion of the main support arm, a direction of F is perpendicular to the plane of the directional frame, and a direction of G is vertically downward. Therefore, as per the geometric relationship of the pointing mechanism, the foregoing equation can be further written in the form of scalar quantities:

$$( F cos {α}_{2} - G cos {α}_{1} ) \cdot {L}_{MSA} δ {α}_{1} + {F}_{HRD} \cdot δ {L}_{HRD} ( {α}_{1} ) = 0$$

From the foregoing paragraphs, it can be known that the relationship between the length of the lower hydraulic rod L_{HRD} and α₁ is:

$${L}_{HRD}^{2} = {l}_{11}^{2} + {l}_{12}^{2} + {l}_{13}^{2} + {l}_{14}^{2} - cos ( {α}_{1} - {tan}^{- 1} \frac{{l}_{14}}{{l}_{11}} + {tan}^{- 1} \frac{{l}_{13}}{{l}_{12}} ) \times 2 \sqrt{( {l}_{11}^{2} + {l}_{14}^{2} ) ( {l}_{12}^{2} + {l}_{13}^{2} )} ,$$

$$When {c}_{1} = {l}_{11}^{2} + {l}_{12}^{2} + {l}_{13}^{2} + {l}_{14}^{2} ,$$

$${c}_{2} = 2 \sqrt{( {l}_{11}^{2} + {l}_{14}^{2} ) ( {l}_{12}^{2} + {l}_{13}^{2} )} ,$$

$${c}_{3} = - {tan}^{- 1} \frac{{l}_{14}}{{l}_{11}} + {tan}^{- 1} \frac{{l}_{13}}{{l}_{12}} ,$$

L_{HRD} can be changed to be:

$${L}_{HRD} = \sqrt{[ {c}_{1} - {c}_{2} cos ( {α}_{1} + {c}_{3} ) ]} ,$$

By variation the following equation is obtained:

$$δ {L}_{HRD} ( {α}_{1} ) = \frac{{c}_{2} sin ( {α}_{1} + {c}_{3} ) δ {α}_{1}}{2 \sqrt{{c}_{1} - {c}_{2} cos ( {α}_{1} + {c}_{3} )}} ,$$

Substituting the last equation in the equation (1) the following equation can be obtained:

$${F}_{HRD} = \frac{( - F cos {α}_{2} + G cos {α}_{1} ) \cdot {L}_{MSA} \cdot 2 \sqrt{{c}_{1} - {c}_{2} cos ( {α}_{1} + {c}_{3} )}}{{c}_{2} sin ( {α}_{1} + {c}_{3} )} ,$$

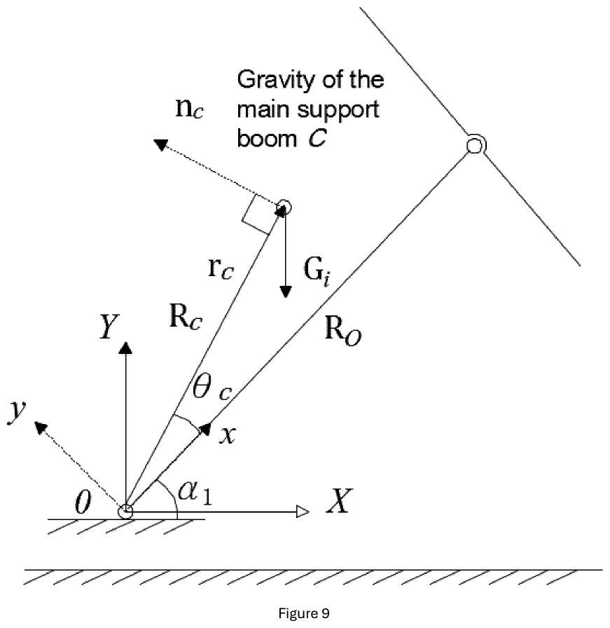

As shown in FIG. 9, in further consideration of general conditions, including influences of gravity of any part fixed on the directional frame Gᵢ and any foreign force Fᵢ, a position vector of action points of these forces in the local coordinate system of the directional frame is rᵢ, the point rᵢ is not necessarily at the hinge at the top portion of the main support arm, therefore, the virtual work that the gravity Gᵢ and the foreign force Fᵢ can be expressed as:

$$δ {W}_{i} = ( {G}_{i} + {F}_{i} ) \cdot {n}_{i} ‖ {R}_{i} ‖ δ {α}_{1} ,$$

Expressing in the form of scalar quantities:

$$δ {W}_{i} = [ {F}_{i} {R}_{i} cos ( {α}_{2} - {θ}_{i} ) - {G}_{i} {R}_{i} cos ( {α}_{1} + {θ}_{i} ) ] δ {α}_{1} ,$$

Wherein Gᵢ=∥Gᵢ∥, Fᵢ=∥Fᵢ∥, Rᵢ=∥Rᵢ∥, θᵢ of is a product obtained by subtracting the included angle between R_{f} and the axis x in the global coordinate system with α₁ and can be expressed to be:

$${θ}_{i} = {cos}^{- 1} \frac{{R}_{i} \cdot X}{{R}_{i}} - {α}_{1} ,$$

$${R}_{i} = {R}_{o} + {A}_{o} {r}_{i} .$$

In the foregoing equation, Aₒ is a conversion matrix from the local coordinate system x-o-y to the global coordinate system X-O-Y, and can be expressed with the included angle between the directional frame and the vertical plane to be:

$${A}_{o} = [ \begin{matrix}cos α & - sin α \\ sin α & cos α\end{matrix} ] ,$$

Assume there are such parts n pieces, which contribute the gravity, add the virtual work to the equation (1), the equation can be simplified to be:

$${\sum }_{i = 1}^{n} [ F cos ( {α}_{2} - {θ}_{i} ) - {G}_{i} cos ( {α}_{1} + {θ}_{i} ) ] {R}_{i} {δα}_{1} + {F}_{HRD} \cdot δ {L}_{HRD} ( {α}_{1} ) = 0 \qquad ( 2 )$$

Wherein −Σᵢ₌₁ⁿGᵢRᵢ cos(α₁+θᵢ)δα₁ this part has considered the special case when the gravity acts on the hinge on the top portion of the main support arm, Σᵢ₌₁ⁿF cos(α₂−θᵢ)δα₁ this part has considered the special case when other external forces act on the hinge on the top portion of the main support arm, and as per the expression for inducing F_{HRD} set forth in the foregoing paragraphs, the following equation can be obtained:

$${F}_{HRD} = \frac{{\sum }_{i = 1}^{n} [ - F cos ( {α}_{2} - {θ}_{i} ) + {G}_{i} cos ( {α}_{1} + {θ}_{i} ) ] {R}_{i} \cdot 2 \sqrt{{c}_{1} - {c}_{2} cos ( {α}_{1} + {c}_{3} )}}{{c}_{2} sin ( {α}_{1} + {c}_{3} )} ,$$

On this basis, in further consideration of the gravity of the main support arm G_{C}, and a spatial vector corresponding to the action point of the gravity on the main support arm in the local coordinate system is r_{C}, therefore, the virtual work that the gravity plays can be expressed as:

$$δ {W}_{C} = {G}_{C} \cdot {n}_{C} ‖ {R}_{C} ‖ {δα}_{1} ,$$

Expressing in the form of scalar quantities:

$$δ {W}_{C} = - {G}_{C} {R}_{C} cos ( {α}_{1} + {θ}_{C} ) {δα}_{1} ,$$

Wherein G_{C}=∥G_{C}∥. R_{C}=∥R_{C}∥, θ_{C} is a product obtained by subtracting the included angle between R_{C} and the axis x in the global coordinate system with α₁ and can be expressed as:

$${θ}_{C} = {cos}^{- 1} \frac{{R}_{C} \cdot X}{{R}_{C}} - {α}_{1} , \\ {R}_{C} = {A}_{C} {r}_{C} ,$$

In the foregoing equation, A_{c} is a transformation matrix from the local coordinate system x-O-y to the global coordinate system X-O-Y, and the included angle between the main support arm and the horizontal plane can be expressed as:

$${A}_{C} = [ \begin{matrix}cos {α}_{1} & - sin {α}_{1} \\ sin {α}_{1} & cos {α}_{1}\end{matrix} ] ,$$

Adding the influence of the gravity to the equation (2) the following equation can be obtained:

$${\sum }_{i = 1}^{n} [ F cos ( {α}_{2} - {θ}_{i} ) - {G}_{i} cos ( {α}_{1} + {θ}_{i} ) ] {R}_{i} {δα}_{1} - {G}_{C} {R}_{C} cos ( {α}_{1} + {θ}_{C} ) {δα}_{1} + {F}_{HRD} \cdot δ {L}_{HRD} ( {α}_{1} ) = 0 \qquad ( 3 )$$

As per the expression obtained in the foregoing paragraphs, the following equation can be obtained:

$${F}_{HRD} = \frac{\begin{matrix}\{ {\sum }_{i = 1}^{n} [ - F cos ( {α}_{2} - {θ}_{i} ) + {G}_{i} cos ( {α}_{1} + {θ}_{i} ) ] {R}_{i} + \\ {G}_{C} {R}_{C} cos ( {α}_{1} + {θ}_{C} ) \} \cdot 2 \sqrt{{c}_{1} - {c}_{2} cos ( {α}_{1} + {c}_{3} )}\end{matrix}}{{c}_{2} sin ( {α}_{1} + {c}_{3} )} . \qquad ( 4 )$$

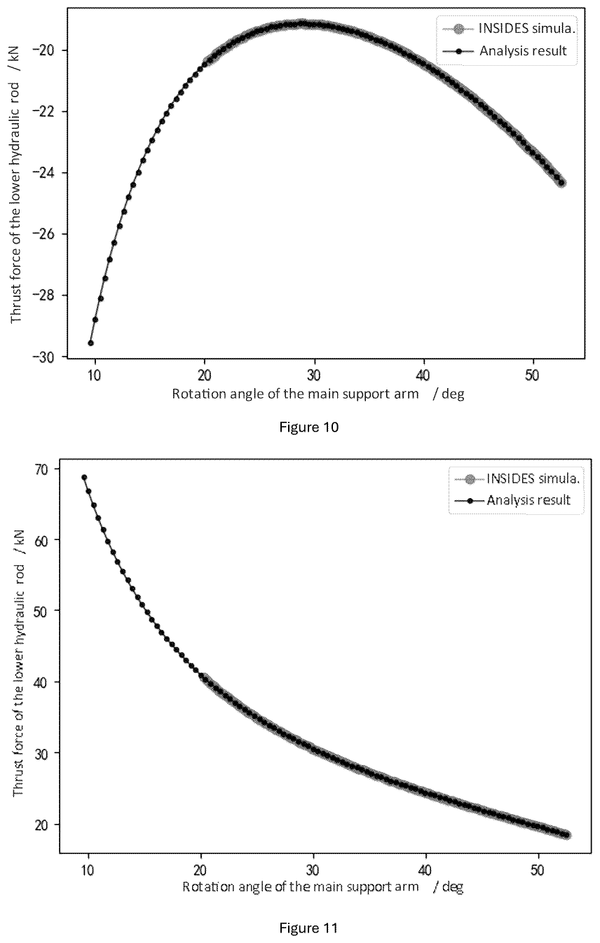

In an embodiment, providing the thrust force from the injector head to be 100 kN, the gravity of the injector head is 10 kN, the dynamics simulation results and the analysis result in the foregoing paragraphs are compared and shown in FIG. 10.

In an embodiment, as shown in FIG. 11, the analysis results are basically consistent with the INSIDES simulation results, and the correctness of the equations is established.

With the foregoing method, the working conditions where the injector head exerts thrust forces 100 kN and pullout forces 100 kN are respectively calculated, and the relationships between the thrust forces of the lower hydraulic rods and the two included angles are as shown in FIG. 11, at this time, the biggest thrust forces that the lower hydraulic rods have are 470.796 kN.

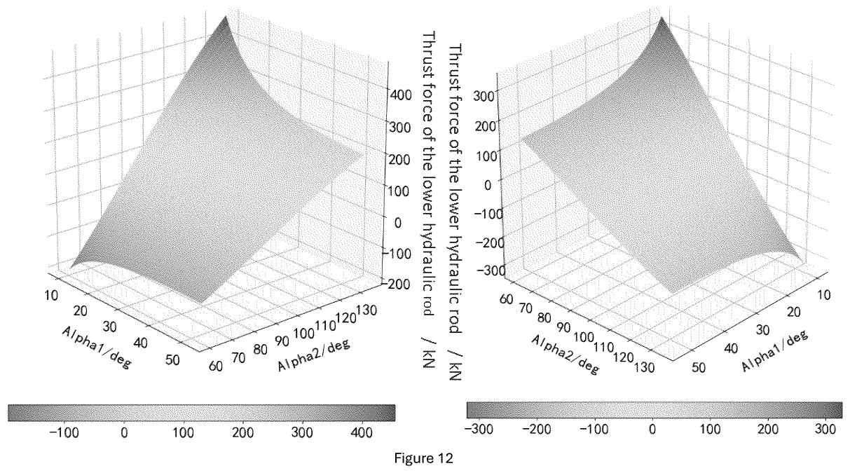

In an embodiment, as shown in FIG. 12, in the drawing at the left side, the working condition with the injector head exerting a thrust force of 100 kN is shown, and in the drawing at the right side, the working condition where the injector head exerts a thrust force of −100 kN is shown. The pointing mechanism has two parameters to be optimized, respectively the installation positions of the lower hydraulic rods on the main support arm and the installation positions of the upper hydraulic rods on the main support arm, that is, l₁₅, l₂₅. The object of optimization is to minimize the biggest thrust force of the lower hydraulic rods in the scope of the working length.

During optimization, a constraint is to be satisfied, that is, the included angle between the directional frame and the vertical plane covers a range of [−10, 90], so as to satisfy the scope of the design objectives.

Furthermore, a boundary is to be satisfied, that is, the installation positions must be located in the range of the length of the main support arm. From the foregoing description, an object function is built as following:

$$\begin{matrix}min & {f}_{max} ( {l}_{15} , {l}_{25} ) \\ s . t . & {α}_{min} ( {l}_{15} , {l}_{25} ) \leq - 10 \\ & {α}_{max} ( {l}_{15} , {l}_{25} ) \geq 90 \\ & 0 \leq {l}_{15} \leq 2 \\ & 0 \leq {l}_{25} \leq 2\end{matrix} ,$$

Wherein, fₘₐₓ(l₁₅/l₂₅) is a function of the maximum thrust force of the lower hydraulic rods in the range of the working length calculated according to 45, 25; and min (l₁₅/l₂₅) and max(l₁₅/l₂₅) are respectively functions of the upper threshold and the lower threshold of the working angle of the directional frame.

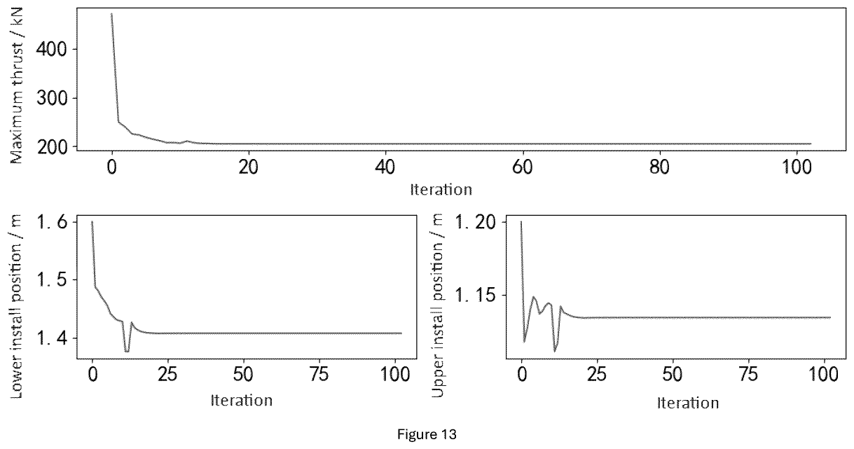

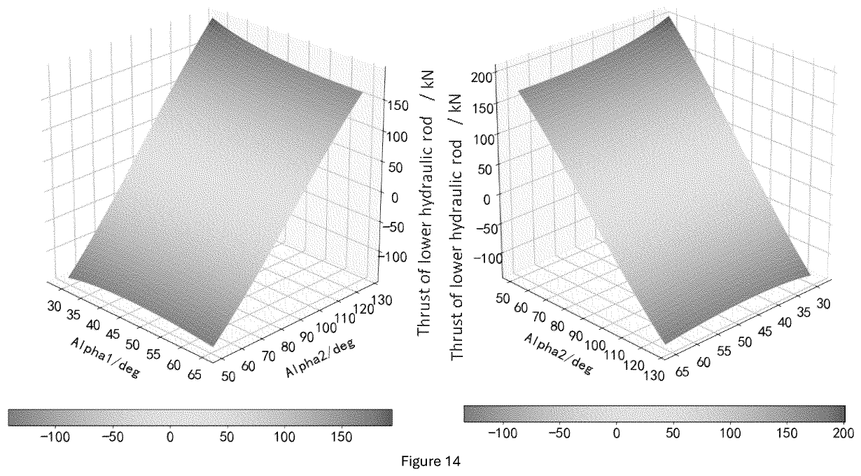

In the foregoing equation, the restriction on the changing of the independent variables is included, therefore, the issue relates to boundary constraint optimization, optimizing and solving the foregoing object function with the trust region constrained optimization algorithm, and calculating the HESSEN matrix with the BFGS method. Selecting the initial design parameters of the pointing mechanism l₁₅=1.6, l₂₅=1.2 as the initial optimization values, and at this time, the maximum thrust forces of the lower hydraulic rods are 470.796 kN. The optimization process is as shown in FIG. 13, after iterating for 122 times, the convergence standard is met, which takes 11 seconds. As shown in FIG. 14, in the left drawing, the working condition with the injector head exerting a thrust force of 100 kN is shown, in the right drawing, the working condition where the injector head exerts a thrust force of −100 kN is shown. The optimization results are as following: the installation positions of the lower hydraulic rods on the main support arm are 1.407 m, the installation positions of the upper hydraulic rods on the main support arm are 1.135 m, and the included angle between the directional frame and the vertical plane falls in a range of [−10.000, 101.369], which agrees with the requirements of the constraints, at this time, the maximum loads of the lower hydraulic rods are 205.222 kN, and compared with the initial value, the maximum loads are reduced for 56.4%.

In the embodiments of the present invention, based on the features of the coiled tubing drilling machines, a special pointing mechanism is designed, and a dynamics design method of the pointing mechanism is proposed in view of the structure of the coiled tubing drilling machines. The drilling machine obtained by building the model and optimization based on the design method in conjunction with actual working conditions has a large inclination angle and height adjustment range, so that the drilling machine can be accommodated to more working conditions, and widen the drilling construction scope. In the present embodiment, by dynamics design methods, the parameters of the pointing mechanism is designed accurately, the requirements on performance of the coiled tubing drilling working space and loads are satisfied and more working conditions can be satisfied.

In an embodiment, the pointing mechanism is connected with the drilling machine and the injector head by a single pivot and two degrees of freedom in the longitudinal direction, so that the injector head of the drilling machine can change in a range of −10 to 90 degrees of inclination angle, the design requirements of thrust forces and pullout forces of the injector head to be 100 kN have been satisfied, the installation positions of the upper hydraulic rods and the lower hydraulic rods on the main support arm of the pointing mechanism to be at 1.135 m and 1.407 m, consequently, the maximum loads of the lower hydraulic rods are 205.222 kN, and are reduced for 56.4% compared with the initial design values, the reliability of the device is improved, so that on the basis of maintaining the hardware device unchanged, the bearing ability is improved to the greatest extent. In an embodiment, a design device of the pointing mechanism is provided, wherein the design device of the pointing mechanism comprises: a pointing mechanism model building module, configured to construct a model of the pointing mechanism, wherein the model of the pointing mechanism at least comprises a first stretching lever, a second stretching lever, a main support arm and a directional frame; wherein one end of the first stretching lever is connected with the main support arm, another end of the first stretching lever is connected with a base frame of the pointing mechanism; one end of the main support arm is connected with the base frame of the pointing mechanism, another end of the main support arm is connected with the directional frame; one end of the second stretching lever is connected with the main support arm, another end of the second stretching lever is connected with the directional frame; an initial component parameter and initial connection relationship parameter acquisition module, configured to obtain initial component parameters representing dimensions of components of the model and initial connection relationship parameters representing connection relationships and/or connection positions among the components of the model; a dynamics model construction module, configured to build a global coordinate system, and define respectively geometric information, topological information and mechanical information of the components of the model in the global coordinate system based on the initial component parameters and the initial connection relationship parameters; and build a dynamics model of the pointing mechanism based on the geometric information, the topological information and the mechanical information of the components of the model; and a simulation and optimization module, configured to obtain working conditions and performance requirements of the pointing mechanism and simulate and optimize the dynamics model based on the working conditions and the performance requirements.

Those skilled in the art readily appreciate that, the present device can be a virtual device, can be a computer program or program module, can be software, so that the present device can have the present apparatus to execute the steps of the design method of the pointing mechanism. In the embodiments of the present invention, based on characteristics of the coiled tubing drilling machine, a special pointing mechanism is designed, and a special dynamics design method of the pointing mechanism is proposed targeted at the structures of the coiled tubing drilling machine. The drilling apparatus obtained by constructing the model and optimizing based on the design method in conjunction with actual working conditions has a large inclination angle and height adjustment range, so that the drilling machine can accommodate to more working conditions, and the drilling construction scope can be enlarged. In the present embodiment, by way of dynamics design, the parameters of the pointing mechanism can be precisely designed, the pointing mechanism can satisfy the performance requirements of coiled tubing drilling working space and loads and adapt to more working conditions.

For description of the design method, please find the foregoing paragraphs, and herein the description will not be repeated. With the present design method, a pointing mechanism with a large inclination and high adjustability is obtained, so that the pointing mechanism can be accommodated to more complex working conditions, the drilling construction scope is widened, and the structural strength of the device can be improved.

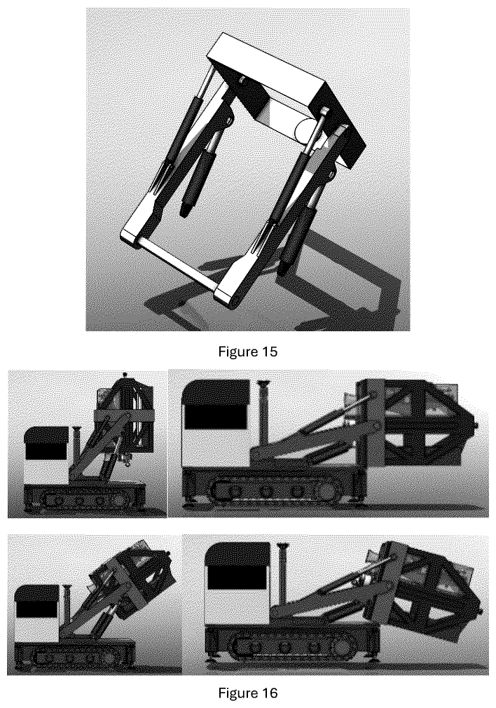

In an embodiment, as shown in FIG. 15 and FIG. 16, a pointing device is respectively provided, and FIG. 16 is a diagram showing the pointing device applied in a drilling machine. The pointing device is designed and optimized as per the design method set forth in the foregoing paragraphs. In the embodiments of the present invention, based on the characteristics of the coiled tubing drilling machine, special pointing mechanisms are designed, and a dynamics design method of the pointing mechanisms are proposed in view of the structure of the coiled tubing drilling machine. The drilling machine obtained by constructing a model and optimizing as per the design method in conjunction with the actual working conditions has a large inclination angle and height adjustment range, so that the drilling machine can be accommodate to more working conditions and the drilling construction scope can be widened. In the present embodiment, by means of dynamics design, the parameters of the mechanism can be designed precisely, so as to meet the performance requirements for coiled tubing drilling construction space and loads and be adapted to more working conditions. For description of the design method please find the foregoing paragraphs, and the design method will not be repeated here.

In an embodiment, the present invention provides a computer readable storage medium, wherein a computer program is stored in the computer readable storage medium, and the computer program when being executed by a processor, will have the processor to execute the steps of the design method as set forth above.

It shall be comprehensible that, although the steps in the flow chart diagram of the embodiments of the present invention are shown sequentially as per indications of arrows, the steps are not necessarily executed sequentially as per the sequence indicated by the arrows. Unless expressly indicated otherwise in the present description, there is no strict limitation on the execution of the steps, and these steps can be executed in other sequences. Furthermore, at least some of the steps in the embodiments can include more than one sub-step or stage, the sub-steps or stages are not necessarily executed at the same time, and can be executed at different times, the sub-steps or the stages are not necessarily executed sequentially, and can be executed in turn or alternately with other steps or sub-steps or stages of the other steps.

Those of ordinary skill in the art can understand all or some processes for realizing the method embodiments of the present invention can be completed by having a computer program to instruct corresponding hardware, the computer program can be stored in a non-volatile computer readable storage medium, the computer program when being executed, can include the flow processes in the foregoing method embodiments. In the present invention, all recitations to storage devices, memories, databases and other media in the embodiments of the present invention include both non-volatile and/or volatile memories. Non-volatile memories can included read-only memory (ROM), programmable ROM (PROM), electronic programmable ROM (EPROM), electronic erasable programmable ROM (EEPROM) or flash memory. Volatile memories can include random access memory (RAM) or external high speed cache memory. Explanatorily rather than restrictively, RAM is obtainable in a plurality of forms, for example, static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), Rambus direct RAM (RDRAM), direct Rambus dynamic RAM (DRDRAM) and Rambus dynamic RAM (RDRAM) etc.

The technical features in the foregoing technical embodiments can be arbitrarily combined, and to ease description, not all possible combinations of the technical features of the embodiments have been described, however, as long as the combinations of the technical features are not contradictory, they shall be deemed to have been included in the protection scope of the present invention.

The foregoing embodiments set forth only some embodiments of the present invention, description thereof is concrete and detailed, however, the description shall not be taken as limitations on the technical scope of the present invention. It shall be pointed out that, for those of ordinary skill in the art, without departing from the technical idea of the present invention, several changes and modifications can be made to the present invention and the changes and modifications fall into the protection scope of the present invention. Therefore, the protection scope of the present invention shall be defined by the appended claims.

1. A design method of pointing mechanism, wherein the method comprises:
building a model for the pointing mechanism, wherein the model of the pointing mechanism at least comprises a first stretching lever, a second stretching lever, a main support arm and a directional frame; wherein one end of the first stretching lever is connected with the main support arm, another end of the first stretching lever is connected with a base frame of the pointing mechanism; an end of the main support arm is connected with the base frame of the pointing mechanism, another end of the main support arm is connected with the directional frame; one end of the second stretching lever is connected with the main support arm, and another end of the second stretching lever is connected with the directional frame;
acquiring initial component parameters representing dimensions of models of components, and parameters of initial connection relationships representing connection relationships and/or connection positions of the models of the components;
building a global coordinate system, defining geometric information, topological information and mechanical information of the models of the components in the global coordinate system;
building a dynamics model for the pointing mechanism based on the geometric information, the topological information and the mechanical information of the models of the components;
acquiring working conditions and performance requirements on the pointing mechanism, and simulating and optimizing the dynamics model based on the working conditions and the performance requirements.

2. The design method of pointing mechanism according to claim 1, wherein spatial relationships between the components of the dynamics model of the pointing mechanism satisfy:
the first stretching lever and the second stretching lever are coplanar but do not contact; a connection point between the second stretching lever and the main support arm is located in between a connecting point between the main support arm and the base frame of the pointing mechanism and a connecting point between the first stretching lever and the main support arm.

3. The design method of pointing mechanism according to claim 1, wherein spatial relationships between the components of the dynamics model of the pointing mechanism further satisfy:
defining a horizontal distance between a middle point O of the directional frame and a hinging point between the base frame and the main support arm as d, a vertical distance to the base frame as h, an included angle between a plane of the directional frame and a vertical guide to be an attitude angle α, defining a direction counterclockwise to be positive, taking the directional frame to be a rigid body, and expressing generalized coordinates of the directional frame to be [d h α],
defining an included angle between the main support arm and a horizontal plane to be α₁, an included angle between the main support arm and the directional frame to be α₂, l₁₅ to be a length of the first stretching lever, l₂₅ to be a length of the second stretching lever, α₁ is dictated by l₁₅, α₂ is dictated by l₂₅, and defining the included angle between the plane of the directional frame and the vertical guide α, α satisfies that:
$$α = {α}_{1} + {α}_{2} - \frac{π}{2} ,$$
defining a length of the main support arm to be L, the horizontal distance d and the vertical distance h are dictated by α₁ only, d and h satisfy:
$$\{ \begin{matrix}d = L \times cos {α}_{1} \\ h = L \times sin {α}_{1} + {l}_{13}\end{matrix} ,$$
as per the law of cosines, relationships between the included angles α₁, α₂ and the lengths of the hydraulic rods l₁₅ and l₂₅ satisfy:
$$\{ \begin{matrix}{α}_{1} = {tan}^{- 1} \frac{{l}_{14}}{{l}_{11}} - {tan}^{- 1} \frac{{l}_{13}}{{l}_{12}} + {cos}^{- 1} \frac{{l}_{11}^{2} + {l}_{12}^{2} + {l}_{13}^{2} + {l}_{14}^{2} - {l}_{15}^{2}}{2 \sqrt{( {l}_{11}^{2} + {l}_{14}^{2} ) ( {l}_{12}^{2} + {l}_{13}^{2} )}} \\ {α}_{2} = π - ( {tan}^{- 1} \frac{{l}_{24}}{{l}_{21}} + {tan}^{- 1} \frac{{l}_{23}}{{l}_{22}} + {cos}^{- 1} \frac{{l}_{21}^{2} + {l}_{22}^{2} + {l}_{23}^{2} + {l}_{24}^{2} - {l}_{25}^{2}}{2 \sqrt{( {l}_{21}^{2} + {l}_{24}^{2} ) ( {l}_{22}^{2} + {l}_{23}^{2} )}} )\end{matrix} .$$

4. The design method of pointing mechanism according to claim 1, wherein obtaining the working conditions and the performance requirements on the pointing mechanism, and optimizing the dynamics model based on the working conditions and the performance requirements comprises:
changing a position of a connection point between the first stretching lever and the main support arm and a position of a connection point between the second stretching lever and the main support arm based on the working conditions and the performance requirements, so to minimize a maximum thrust force on the first hydraulic rod in a range of working length and optimize the dynamics model.

5. The design method of pointing mechanism according to claim 4, wherein changing a position of a connection point between the first stretching lever and the main support arm and a position of a connection point between the second stretching lever and the main support arm based on the working conditions and the performance requirements, so to minimize a maximum thrust force on the first hydraulic rod in a range of working length and optimize the dynamics model, comprising:
building an object function:
$$\begin{matrix}min & {f}_{max} ( {l}_{15} , {l}_{25} ) \\ s . t . & {α}_{min} ( {l}_{15} , {l}_{25} ) \leq - 10 \\ & {α}_{max} ( {l}_{15} , {l}_{25} ) \geq 90 \\ & 0 \leq {l}_{15} \leq 2 \\ & 0 \leq {l}_{25} \leq 2\end{matrix} ,$$
wherein, fₘₐₓ(l₁₅,l₂₅) is a function of the maximum thrust force of the lower hydraulic rods in a range of the working length calculated according to l₁₅, l₂₅; and αₘᵢₙ(l₁₅,l₂₅) and max(l₁₅,l₂₅) are respectively functions of an upper threshold and a lower threshold of a working angle of the directional frame;
optimizing and solving the object function with the trust region constrained optimization algorithm, and calculating the HESSEN matrix with a Broyden-Fletcher-Goldfarb-Shanno (BFGS) algorithm;
obtaining initial parameters of l₁₉,l₂₅ as initial optimization values, iterating the object function until convergence, and obtaining optimized values of l₅₉,l₂₅.

6. The design method of pointing mechanism according to claim 1, wherein attitudes of the main support arm, the directional frame, the first stretching lever and the second stretching lever, a position of the directional frame, and a position of the first stretching lever, are dictated by a height of the directional frame and an angle of the directional frame, and satisfy:
$${α}_{MSA} = arc sin \frac{h}{{L}_{MSA}} ,$$
wherein, L_{MSA} is a length of the main support arm, h is a height of the directional frame and α_{MSA} is an attitude angle of the main support arm.

7. The design method of pointing mechanism according to claim 1, wherein the design method of the pointing mechanism further comprises:
obtaining bearing conditions of the first stretching lever and the second stretching lever based on a virtual work principle and optimizing parameters of the dynamics model of the pointing mechanism.

8. A design device of the pointing mechanism, wherein the design device of the pointing mechanism comprises:
a pointing mechanism model construction module, configured to build a model for the pointing mechanism, wherein the model of the pointing mechanism at least comprises a first stretching lever, a second stretching lever, a main support arm and a directional frame; one end of the first stretching lever is connected with the main support arm, another end of the first stretching lever is connected with a base frame of the pointing mechanism; one end of the main support arm is connected with the base frame of the pointing mechanism, another end of the main support arm is connected with the directional frame; one end of the second stretching lever is connected with the main support arm, another end of the second stretching boom is connected with the directional frame;
an initial component parameter and initial connection relationship parameter acquisition module, configured to represent initial component parameters of dimensions of models of components and parameters of initial connection relationships of connection relationships and/or connection positions among the models of the components;
a dynamics model construction module, configured to build a global coordinate system, and define geometric information, topological information and mechanical information of the models of the components based on the initial component parameters and the parameters of the initial connection relationships; and building a dynamics model for the pointing mechanism based on the geometric information, the topological information and the mechanical information; and
a simulation and optimization module, configured to acquire working conditions and performance requirements of the pointing mechanism and simulate and optimize the dynamics model based on the working conditions and the performance requirements.

9. A computer readable storage medium, wherein, a computer program is stored in the computer readable medium, and the computer program when being executed by a processor, will have the processor execute steps of the design method of the pointing mechanism as defined in claim 1.

10. A pointing mechanism, wherein the pointing mechanism is obtained by executing the design method of pointing mechanism as defined in claim 1.
